(19) United States
(12) Patent Application Publication
(10) Pub. No.: US 2003/0105652 A1
(43) Pub. Date: Jun. 5, 2003

(54) System, method, and computer program product for managing an investment to increase the after-tax death benefit of the investment

(76) Inventors: Robert Arena, Farmington, CT (US); Robert O'Donnell, Harwinton, CT (US); Robert Schwartz, West Granby, CT (US); N. David Kuperstock, Woodbridge, CT (US); Tim Paris, Guilford, CT (US); Robert Leach, Weston, CT (US); Jacob Herschler, Southport, CT (US); Mike Morrell, Shelton, CT (US); Fiona Jackman-Ward, Stratford, CT (US)

Correspondence Address: ROTHWELL, FIGG, ERNST & MANBECK, P.C., 1425 K STREET, N.W., SUITE 800, WASHINGTON, DC, 20005, US

(21) Appl. No.: 10/121,908

(22) Filed: Apr. 12, 2002

Related U.S. Application Data
(60) Provisional application No. 60/283,718, filed on Apr. 13, 2001.

(51) Int. Cl. G06F 17/60

(52) U.S. Cl. 705/4

(57) ABSTRACT

A system, method, and computer program product for managing an investment to increase the after-tax death benefit of the investment received by the beneficiaries, the system comprising a processor, a memory, and a computer program stored in the memory. The computer program receives and stores information relating to an investment and periodically assesses the value of the investment. The computer program then determines an insurance premium that will provide a death benefit based on the assessed value of the investment. Next, the computer program collects or otherwise receives information of receipt of the insurance premium. In the preferred embodiment, the insurance premium provides a life insurance death benefit of forty percent (40%) of the assessed value of the investment. Because the maximum federal tax on the investment is approximately thirty-six percent (36%) of the investment value, even if the investment were purchased with appreciated assets, the life insurance death benefit ensures that the beneficiaries receive an after-tax death benefit that is substantially equal to or greater than the pre-tax value of the investment.

### CROSS REFERENCE TO RELATED APPLICATION

This non-provisional application claims the benefit of the earlier filing date of, and contains subject matter related to that disclosed in, U.S. Provisional Application Serial No. 60/283,718, filed Apr. 13, 2001 having common inventorship, the entire contents of which are incorporated herein by reference.

### BACKGROUND OF THE INVENTION

1. Field of the Invention

This invention relates to the field of investment management and, in particular, to a system, method, and computer program product for managing an investment to increase the after-tax death benefit of the investment received by the beneficiaries.

2. Description of Related Art

A continuing challenge of investment management is to provide investment products that match an investor's objectives. One common objective of an investor is to save for retirement to allow the investor to live comfortably during retirement. Another common objective of an investor is to pass the remaining assets to his or her heirs on a tax efficient basis if the investor dies before using the accumulated assets.

Annuities are a common form of investment vehicle that permits the investor to save for retirement on a tax-deferred basis, that can provide a stream of payments during retirement, and that can also provide a death benefit to the investor's heirs at the investor's death. The stream of payments from an annuity is funded with an initial principal amount, commonly termed a contract amount. Periodic payments are provided, based on the value of the annuity contract at the time payments are to begin, the annuitant gender, the number of payments that are anticipated to be made from this annuity, and other factors. Annuities are available in many forms. The distributions may be made for a predetermined definite period, as in an annuity certain, or for as long as the person lives, as in a life annuity. Payments under a life annuity may terminate on the annuitant's death, as in a straight life annuity, or may continue to a beneficiary for a specified period after the annuitant's death, as in a life annuity with period certain. The payments under an annuity may be set to begin one payment after purchase of the annuity, as in an immediate annuity, or after an amount of time, which may or may not be predetermined, as in a deferred annuity.

As discussed, annuities often provide a death benefit to the beneficiaries at death. During the deferred period of a deferred annuity, the benefit may be triggered by the death of an owner, annuitant or either, dependent on the contract terms. Generally, once payment begins, it is the annuitant's death that triggers payment of any death benefit. While owners and annuitants may be the same, such is not required, and owners may be entities.

The amount of the death benefit of the annuity ultimately received by the beneficiary is often reduced by a tax, which is assessed on any gain in the investment (annuity). Furthermore, not only is the gain of the investment taxed, but the gain present in the assets used to purchase the investment, which may include gain from a previous tax-deferred investment, is also taxed. Specifically, the gain of the investment is taxed as ordinary income, which is typically thirty-six percent (36%) for federal taxes in the United States, and results in a substantial reduction in the after-tax benefits received by the beneficiary.

Referring to FIG. 1A, which is a representation in block diagram form of a first type of example investment product according to the prior art, an investor purchases an annuity for a $300,000 purchase payment 210 with $200,000 of the purchase payment being paid with growth 230 from a previous tax-deferred investment and $100,000 being paid from after-tax assets 220. Assuming in this example that the investor dies after five years and the investment yields a ten percent rate of return per year, the investment would be worth $483,153 at death. As discussed, the growth portion of the after-tax benefit (i.e., the gains 230 and 240) is taxed as ordinary income. Assuming the beneficiary takes the death benefit as a lump sum, the taxes on this death benefit are assessed on the gain ($383,153) at a rate of thirty-six percent (36%) or $137,935 (250). As a result, the after-tax lump sum death benefit received by the beneficiaries would be the investment value minus the tax 250 or a total of $345,217 of after-tax death benefit 260.

Thus, one obstacle to passing on assets to the investor's beneficiaries is the applicable taxes on the death benefit proceeds. As is known in the art, however, in the United States the death benefit from life insurance generally is payable to the beneficiaries income tax-free. (However, the life insurance benefit is included in the estate and is subject to estate taxes.) FIG. 1B is a representation in block diagram form of a second type of example investment product according to the prior art. The prior art investment product shown in FIG. 1B is an annuity product that provides a life insurance benefit (that is in addition to the annuity death benefit) that is designed to equal fifty percent (50%) of the annuity's growth. Using the example of FIG. 1A, the additional life insurance benefit would be fifty percent (50%) of the growth 240 of $183,153 ($483,153 minus $300,000) or $91,576 (tax free) as shown in FIG. 1B. Thus, the total after-tax benefit received by the beneficiaries in the above example would be $91,576 of life insurance benefit 280 plus $345,217 of after-tax investment death t benefit 260 for a total after-tax death benefit 290 of $436,793. While the prior art does increase the after-tax benefit, it fails to consider the fact that the annuity's purchase payment may be made with appreciated tax-deferred assets, which represent gain from a prior investment. As a result, the prior art product does not compensate for loss to the beneficiary of any portion of the purchase payment to taxes. It is worth noting that in both examples, the after-tax death benefits 260 and 290 received by the beneficiaries is less than the value of the underlying investment amount 270.

As noted above, the life insurance can maximize the after-tax benefits to a beneficiary receiving death benefit proceeds from any investment product where the beneficiary owes tax on tax-deferred gains. However, the prior art provides life insurance death benefits that are calculated and charged for either the gains in the investment, or are only tied to the gains in the specific product (ignoring prior tax- deferred appreciation) or are only offered in conjunction to gains in an investment that earns interest, rather than an investment with a value tied to the performance of equities or investment companies.

In addition, the prior art requires underwriting of the insured life to obtain amounts of individual life insurance to address the funds payable to beneficiaries in connection with premature death of an investor able to amass substantial tax-deferred assets. (Substantial amounts of life insurance generally are only made available without underwriting in group insurance situations, where the eligibility for the insurance is triggered by an event unconnected to the insured's mortality expectations, such as at the time the insured starts a new job.) Therefore, notwithstanding the available investment products and options, there is a need for a system, method, and computer program product for managing an investment to increase the after-tax death benefit of the investment received by the beneficiaries (1) that can provide a greater after-tax benefit to beneficiaries than existing investment products; (2) that can provide an increasing or decreasing death benefit as the value of the underlying investment increases or decreases (whether due investment performance, withdrawals, or deposits); (3) that can be combined with almost any investment product whether offering fixed or variable (e.g., market-based) returns; (4) that can provide greater after-tax benefits to beneficiaries when the investment product is purchased with appreciated tax-deferred assets than existing products; (5) that can provide the investor with control of investments, allowing the investor to shift investments among investment products and options; (6) that provides a tax-free death benefit without underwriting; and (7) that can provide an after-tax death benefit that is substantially equal to or greater than the value of the underlying investment.

### SUMMARY OF THE INVENTION

The primary object of the present invention is to overcome the deficiencies of the prior art described above by providing a system, method, and computer program product for managing an investment to increase the after-tax death benefit of the investment.

Another object of the present invention is to provide a system, method, and computer program product for managing an investment that provides a death benefit that varies according to the value of the underlying investment, irrespective of the type of underlying investment.

Yet another object of the present invention is to provide a system, method, and computer program product for managing an investment that can provide an after-tax death benefit that is substantially equal to or greater than the pre-tax value of the investment.

Still another object of the present invention is to provide a system, method, and computer program product for managing an investment that provides greater after-tax benefits to beneficiaries when appreciated tax-deferred assets are used to purchase the investment than existing investment products.

Another object of the present invention is to provide a system, method, and computer program product for managing an investment that provides increased after-tax death benefits for a wide range of investments and investment products.

Still another object of the present invention is to provide a system, method, and computer program product for managing an investment that provides increased after- tax death benefits without requiring underwriting.

The present invention achieves these objects and others by providing a system, method, and computer program product for managing an investment to increase the after-tax death benefit of the investment, the system comprising a processor, a memory, and a computer program stored in the memory. The computer program receives and stores information relating to an investment and periodically assesses the value of the investment. The computer program then determines an insurance premium that will provide a death benefit based on the assessed value of the investment. Next, the computer program collects the insurance premium by, for example, debiting assets not included in the investment or debiting assets of the investment. In the preferred embodiment, the insurance premium provides a life insurance death benefit of forty percent (40%) of the assessed value of the investment. By selecting the life insurance death benefit to be greater than the estimated maximum income tax on the investment, the life insurance death benefit ensures that the beneficiaries receive an after-tax death benefit that is substantially equal to or greater than the pre-tax value of the investment even if the investment were purchased with appreciated assets.

Further features and advantages of the present invention, as well as the structure and operation of various embodiments of the present invention, are described in detail below with reference to the accompanying drawings.

### BRIEF DESCRIPTION OF THE DRAWINGS

The accompanying drawings, which are incorporated herein and form part of the specification, illustrate various embodiments of the present invention and, together with the description, further serve to explain the principles of the invention and to enable a person skilled in the pertinent art to make and use the invention. In the drawings, like reference numbers indicate identical or functionally similar elements.

A more complete appreciation of the invention and many of the attendant advantages thereof will be readily obtained as the same becomes better understood by reference to the following detailed description when considered in connection with the accompanying drawings, wherein:

FIG. 1A is a representation in block diagram form of a first type of example investment product in accordance with the prior art.

FIG. 1B is a representation in block diagram form of a second type of example investment product accordance with the prior art.

FIG. 1C is a representation in block diagram form of an investment managed in accordance with the system, method, and computer program product of the present invention for managing an investment to increase the after-tax death benefit of the investment.

FIG. 2 is a flow diagram representing the method steps for managing an investment to increase the after-tax death benefits of the investment in accordance with the system, method, and computer program product of the present invention.

FIG. 3 is a flow diagram representing the method steps for managing an investment to increase the after-tax death benefits of the investment upon modification or termination of the investment or insurance in accordance with the system, method, and computer program product of the present invention.

FIG. 4 is a timing diagram showing representative investment values and time intervals for an example variable annuity product managed in accordance with the system, method, and computer program product of the present invention for managing an investment to increase the after-tax death benefit of the investment.

FIG. 5 is an illustration of a representative computer system for implementing the system, method, and computer program product of the present invention for managing an investment to increase the after-tax death benefit of the investment.

### DETAILED DESCRIPTION OF THE INVENTION

In the following description, for purposes of explanation and not limitation, specific details are set forth, such as particular networks, systems, computers, terminals, devices, components, techniques, software products and systems, enterprise applications, operating systems, financial equations, financial formulas, financial algorithms, hardware, methods of debiting funds, transferring assets, and computing insurance premiums and rates, etc. in order to provide a thorough understanding of the present invention. However, it will be apparent to one skilled in the art that the present invention may be practiced in other embodiments that depart from these specific details. Detailed descriptions of well-known networks, systems, computers, terminals, devices, components, techniques, software products and systems, enterprise applications, operating systems, financial equations, financial formulas, financial algorithms, hardware, methods of debiting funds, transferring assets, and computing insurance premiums and rates, etc. are omitted so as not to obscure the description of the present invention.

This invention presents a process for managing an investment to increase the after-tax death benefits of the investment received by the beneficiaries. For ease of understanding, this invention is presented in the context of a deferred annuity prior to the initiation of the stream of annuity payments, although the principles of this invention are not limited to deferred annuities, nor to any particular investment product. For example, the present invention could be applied to a money market account, IRC Section 1035 exchanges (which cover tax-free transfers of non-qualified annuity contracts, the non-qualified version of a qualified plan rollover), qualified plan rollovers, mutual funds, a savings account, a checking account, or other tax-deferred savings program to provide greater after-tax death benefits to the beneficiaries. While the present invention may be used in conjunction with any investment vehicle, the insurance risks involved in guaranteed issue of the benefit make it most suitable for use with an investment portfolio, investment product, or investment that has a death benefit, a portion of which is diminished by taxes, and in particular income taxes, but possibly by other transfer costs (e.g., estate taxes, estate executor fees) at inheritance. These and other applications of this invention will be evident to one of ordinary skill in the art in view of this disclosure.

I . Method of Managing an Investment in Accordance With the Present Invention

The system, method, and computer program product of the present invention manages an investment to increase the after-tax death benefit of the investment received by the beneficiaries. In accomplishing this benefit and others, the invention provides a life insurance death benefit that is additional to any death benefit of the investment and that is based on the value of the investment.

As is known to those skilled in the art, beneficiaries are often taxed on that portion of the inherited investment death benefit that is considered gain of the principal amount of the original investment. In the United States, the gain is taxed as ordinary income, which may be as high as thirty-six percent (36%) for federal taxes. In addition, not only is the growth of the investment providing the death benefit taxed, gain realized by a previous tax-deferred investment and used to purchase the assets of the investment is also taxed (e.g., a prior annuity contract that had $100,000 of appreciation before it was subject of a 1035 exchange to a new annuity may have gain realized from the prior investment as well as any gain on the new investment).

Life insurance death benefits, however, generally are received by the beneficiaries tax-free. The present invention determines a life insurance benefit that is based on the value of the investment. This benefit is designed to provide a life insurance benefit to offset the taxes if the death benefit is provided as a lump sum - either partially or completely. In the preferred embodiment, the life insurance death benefit is equal to or slightly greater than the current maximum value of the Federal and state income taxes that would be due on the investment death benefit if the entire investment were considered gain and taxed at the highest tax rate (e.g., if all of the assets used to purchase the investment were appreciated assets). By selecting the value of the life insurance death benefit to be slightly greater than the tax assessed at the maximum current tax rate, the investor is assured that the investor's beneficiaries are more likely to receive the full value of the assets of the investment as an after-tax benefit regardless of what percentage of the investment was purchased with appreciated assets. Should the value of the life insurance death benefit be slightly greater than the tax incurred at the maximum tax rate, the life insurance benefit not only offsets the taxes, but may also offset the premiums paid for the life insurance and other management and administration fees.

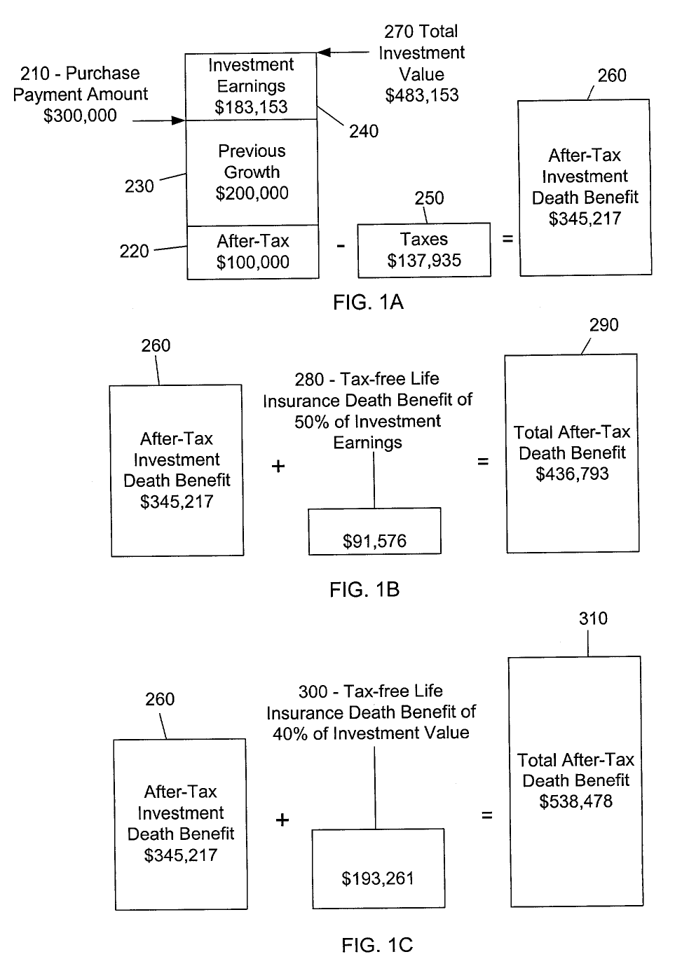

The benefits of the present invention are most easily illustrated when compared to the prior art. FIG. 1C is a representation in block diagram form of an investment managed in accordance with the system, method, and computer program product of the present invention for managing an investment to increase the after-tax death benefit of the investment. The investment product illustrated in FIG. 1C illustrates the additional life insurance benefit enabled by the system, method, and computer program product of the present invention applied to the investment of FIG. 1A. Specifically, the additional life insurance death benefit provided by the life insurance of the preferred embodiment is forty percent (40%) of the total investment value. In this example, the total investment value 270 at the death of the investor is $483,153 and forty percent of this value is $193,261 (300), which is received by the beneficiaries tax-free as a life insurance death benefit. Consequently, the total after-tax lump sum benefit 310 receivable by the beneficiaries would be $193,261 (300) plus $345,217 (260) or $538,478 (310). Thus, the present invention provides an increase in the after-tax death benefit that offsets taxes even if the purchase payment is made with appreciated assets. As a result, the beneficiaries receive an after-tax death benefit that is greater than the pre-tax value of the investment.

II. System Software

The system and method of the present invention is preferably implemented in a programmed general purpose computer running a computer program comprised of software modules implementing the process of the present invention for managing an investment to increase the after-tax death benefit received by beneficiaries. The architecture, design, modules, and code of the software of the present invention could be implemented in a variety of ways and the manner in which it is implemented is largely a matter of design choice well within the ordinary skill level of those skilled in this art. Further, the data stored in memory and used by the computer program is dependent on the software implementation of the present invention. As would be evident to one skilled in the art, the results of the computations for implementing the present invention, such as determined insurance premiums, death benefit amounts, insurance premium rates, investor information, investment information, and other information are stored in memory and retrieved from memory as needed.

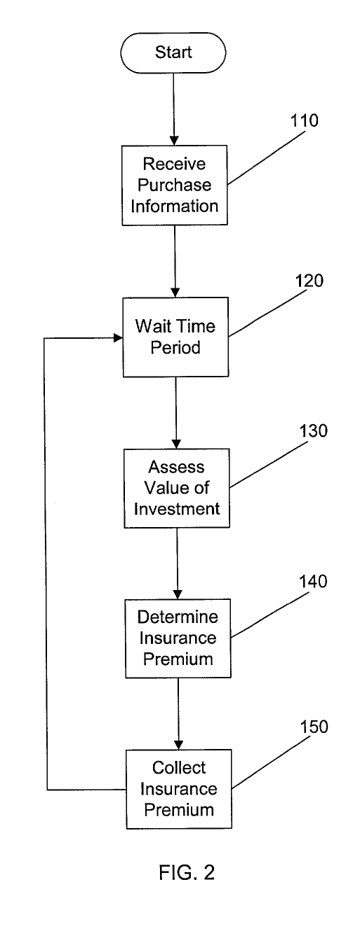

As discussed, the present invention manages an investment to increase the after-tax benefit of the investment received by the beneficiaries. In providing this benefit and others, one example embodiment of the system, method and computer program product of the present invention performs the steps illustrated in FIG. 2. FIG. 2 is a flow diagram representing the method steps for managing an investment to increase the after-tax death benefits of the investment in accordance with the system, method, and computer program product of the present invention.

With reference to FIG. 2, at step 110, the investor places assets in an investment, which may include a purchase of stock, a transfer of assets to a particular investment account, purchase of an annuity, or any other means of placing assets in an investment. As a result of the assets being placed in the investment, the computer program receives and stores information relating to the investment such as information for identifying and valuing the assets (e.g., the investment symbol and number of shares or units). Alternately, information may be received which simply provides a means for the computer program to later assess the value of the investment and, therefore, might include a memory address, a data base table, or an Internet address for retrieving information of the investment. The information received and stored will be dependent on the number and type of investments, how the assets were placed in the investment, where the necessary information is available, and other factors. While the example embodiments utilize only one investment product, the invention is equally well suited for use with assets distributed among any number of investment products and/or investments.

After waiting a time period at step 120, the value of the investment(s) is assessed at step 130. The duration of the waiting period preferably coincides with the time between premium payments for the life insurance. However, the waiting period, and time between each assessment, is a design choice as will be evident to one skilled in the art. The value of the investment is assessed through any suitable means which may include, for example purposes only, 1) retrieving share prices (or unit prices) from a computer network and using the share prices (or unit prices) with information of the number of shares (or units) held by the investor, which is stored in memory, to compute the investment value; 2) receiving the investment value in response to a request; 3) retrieving the investment value from memory; or 4) some combination of these processes.

Next, based on the assessed value of the investment(s) and information relating to the insured (e.g., the investor), an insurance premium is determined at step 140. In an alternate embodiment, step 140 might also include first determining a life insurance death benefit amount, which is used to determine the insurance premium. As discussed below, this step may use predetermined insurance premium rates that are based on the age of the insured, or any other suitable means of calculating an insurance premium rate that provides a death benefit that is based on the value of the investment. There are numerous means of determining an insurance premium known in the art (e.g., based on a rate per thousand dollars of death benefit) and, therefore, the details of determining the insurance premium are not repeated here.

At step 150, the insurance premium is received—preferably being debited from assets of the investor. The insurance premium may be deducted from assets outside of the investment, within the investment, or billed to and paid by the investor as elected by the investor. The insurance premium is used to insure the life of the investor for an amount that is based on the assessed value of the investment. In the preferred embodiment, the insurance premium provides a life insurance death benefit of forty percent (40%) of the assessed value of the investment(s).

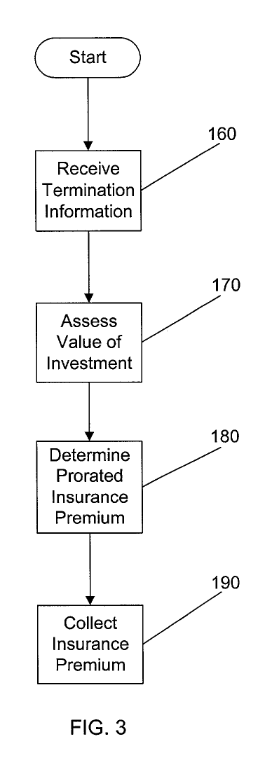

Unscheduled modifications to the investment and/or to the associated life insurance may also require assessment and collection of an insurance premium. For example, the death of the investor, the partial withdrawal (surrender) of the investment (e.g., an annuity), termination of the insurance benefit, or other similar event may require collecting an insurance premium according to the method steps of FIG. 3. In an alternate embodiment in which premiums are collected in advance, such an event may require returning a prorated portion of the previously collected premium. As shown at step 160, information relating to the termination is received and stored, which includes the date of the termination or withdrawal (in order to determine the prorated portion of the time period for which an insurance premium is due or returnable) and may include the value of the withdrawal (in the case of a surrender or withdrawal) or new value of the investment. Other information as necessary may also be received and stored depending on the event and implementation of the present invention. Next, at step 170 the value of the investment is assessed as discussed above. At step 180, the system determines the prorated insurance premium due (or returnable) based on the value of the assets (prior to the withdrawal or termination), the prorated portion of the time period between insurance premiums, the age of the investor and other factors. At step 190, the insurance premium is collected (or returned).

III. Representative Example Annuity Product Managed in Accordance with the System, Method, and Computer Program Product of the Present Invention

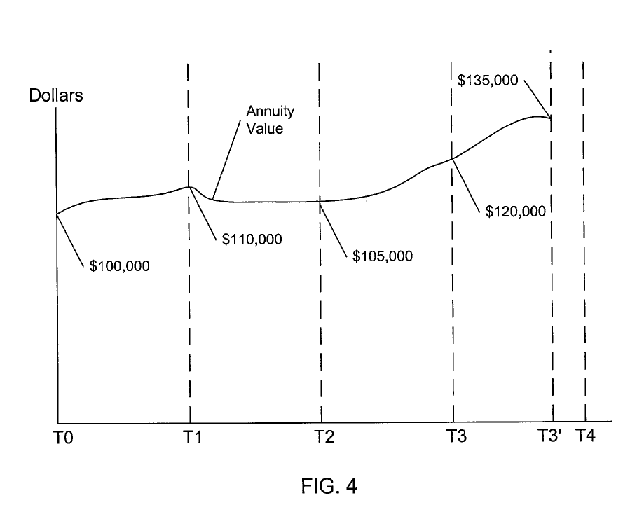

FIG. 4 is a timing diagram showing representative investment values, appreciated amounts, growth, value assessments and time periods for an example annuity product managed in accordance with the system, method, and computer program product of the present invention. As noted above, this invention is presented using the paradigm of an annuity, although one of ordinary skill in the art will recognize that the concepts presented are not limited to annuities.

In this example scenario, the investor, whose death will trigger payment of the death benefit, is seventy-three years of age on the purchase date of the annuity. As illustrated, the investor purchases the annuity as an Individual Retirement Annuity at time T0 for a purchase payment of $100,000. Fifty percent (50%) or fifty thousand dollars of the assets used to purchase the annuity is previously earned growth (gain)—such as growth within an Individual Retirement Account (IRA) (pre-tax assets), a previous annuity contract or other Qualified pension plan.

Referring now to FIG. 2, at step 110, the computer program implementing this example embodiment of the present invention receives and stores information of the purchase date, the purchase payment, the birth date of the insured, the particular investments of the annuity (which may be selected by the investor), and other information relating to the investor and the annuity in memory. In addition, other information necessary for the computation of the insurance amount and premium is stored in memory as is well-known in the art. In this example embodiment, the insurance premium is comprised of a Current charge . For example, in this embodiment the Current Charge of the insurance premium is computed according to the data shown in TABLE 1 below, which is stored in memory.

TABLE 1

| | Insurance Premium |
|---|---|
| | as a Percentage |
| | of the |
| Attained Age | Investment Value |
| 40-75 | 0.80% |
| 76-80 | 1.6% |
| 81-85 | 3.2% |
| 86-90 | 4.8% |
| 91 | 6.5% |
| 92 | 7.5% |
| 93 | 8.5% |
| 94 | 9.5% |
| 95 | 10.5% |

The premium for the life insurance benefit is subject to increase at any time, but not above a stated Guaranteed Charge. The Guaranteed charge is expressed as a rate per thousand of dollars at risk and varies by attained age. In the following example, however, the Current Charges do not exceed the Guaranteed charge. Alternate embodiments of the present invention may use mortality tables, formulas, and/or other data or means to determine the insurance premium, which may or may not have a Current/Guaranteed charge structure.

In the example employing the preferred embodiment, one year after the purchase date (after waiting the time period according to step 120), the computer program of the present invention assesses the value of the investment according to step 130 of FIG. 2. This may be accomplished by retrieving the value of the assessments from memory, retrieving the share value of the investments from a computer network and using the share value to compute the investment value, or any suitable means as is well-known in the art.

As shown in FIG. 4, the value of the annuity has increased to $110,000 at T1. Next, the computer program determines an insurance premium according to step 140 of FIG. 2. After one year, the investor is seventy-four years of age, which is determined by using the current date and the date of birth of the investor stored in memory. Thus, according to the data of TABLE 1, the insurance premium is 0.80% of the assessed investment value of $110,000 or $880.00. This premium is compared with the Guaranteed charge, which as described above, is a maximum charge. As discussed above, in an alternate embodiment, step 140 also includes determining the then current life insurance death benefit amount, which in this example would be forty percent (40%) of $110,000 or $44,000 and which is used to subsequently determine the insurance premium.

Next, the computer program implementing the invention collects (or receives) the insurance premium according to step 150. In this example scenario, this step is accomplished by deducting the premium from assets outside of the annuity, which may include modifying an internal database (e.g., if the company managing the annuity also holds the assets), transmitting an appropriate request to sell assets and transfer funds, transmitting a debit request to a bank or other institution holding assets of the investor, or billing the investor. Optionally, the premium may be deducted (or otherwise automatically debited) from assets in the investment and the investor may select the method of paying the insurance premium. Preferably, the insurance premium is paid from assets that,. when liquidated, incur the lowest tax liability and has no impact on the amount of the death benefit.

After the collection of the insurance premium is completed at step 150, the computer program stores the new values of the assets, if necessary, and other information as would be evident to one skilled in the art. For example, this information may not need to be stored if the insurance premium is collected from assets outside of the investment (because the value of the assets in the investment would not change) and is not needed for reporting purposes. In addition, if the value of the assets is retrieved from a separate computer system, which itself stores information of the new investment value resulting from a debit, the new value of the assets may not need to be stored locally.

At the end of the next time period, the computer program of the present invention assesses the value of the investment according to step 130 of FIG. 2 as discussed above. As shown in FIG. 4., the value of the investment has decreased to $105,000 at T2.

Next, the computer program determines an insurance premium according to step 140 of FIG. 2. After another year the investor is seventy-five years of age. Thus, according to the data of TABLE 1, the insurance premium is 0.80% of the assessed investment value of $105,000 or $840.00. This premium is compared with the Guaranteed charge, which as described above, is a maximum charge. Again, in an alternate embodiment, this step includes determining a life insurance death benefit.

After the collection of the insurance premium is completed at step 150, the computer program stores the new values of the assets (if necessary) and other information necessary for implementation of this embodiment of the invention as discussed above.

After waiting another time period according to step 120, the computer program of the present invention assesses the value of the investment according to step 130 of FIG. 2. As shown in FIG. 4., the value of the investment has increased to $120,000 at T3.

Next, the computer program determines the insurance premium according to step 140 of FIG. 2. After another year the investor is seventy-six years of age. Thus, according to the data of TABLE 1, the insurance premium rate has increased to 1.6% of the assessed investment value. Thus, the current insurance premium is calculated as 1.6% of $120,000 or $1920.00. This premium is compared with the Guaranteed charge, which as described above, is a maximum charge.

After collection of the insurance premium is completed at step 150, the computer program stores the new values of the assets (if necessary) and other information necessary for implementation of this embodiment of the invention.

After seventy-five percent of the next time period has lapsed, the computer program receives information that the investor has died (time T3′). The computer program of the present invention receives the termination information according to step 160 of FIG. 3. FIG. 3 is a flow diagram representing the method steps for managing an investment to increase the after-tax death benefits of the investment upon modification or termination of the investment or insurance in accordance with the system, method, and computer program product of the present invention. The termination information includes the date of the termination (e.g., the date of the death of the investor or date due proof is received regarding the death of the investor), which is used to compute the prorated portion of the time period for which the life insurance premium must be paid. Next, the computer program assesses the value of the investment according to step 170 of FIG. 3. As shown in FIG. 4., the value of the investment has increased to $135,000 at T3′.

Next, the computer program determines an insurance premium according to step 180 of FIG. 3. At time T3′, the investor is seventy-seven years of age. Thus, according to the data of TABLE 1, the insurance premium rate is 1.6% of the assessed investment value. However, the insurance premium rates of TABLE 1 are annual rates. Thus, because the investor died mid way through the year, and the insurance premium rate to be applied must be for that portion of the year the investor was alive, the computer program computes a prorated insurance premium that is based on the prorated portion of the year the investor was alive, the investor's age and the applicable rate of TABLE 1. Thus, the insurance current premium is calculated as seventy-five percent (75% being the portion of the year the annuitant was alive) multiplied by 1.6% (the current annual insurance premium rate) multiplied by the assessed value of the investment of $135,000, which results in an insurance premium of $1620.00. This premium is compared with the Guaranteed charge, which as described above, is a maximum charge.

Next, the insurance premium is collected at step 190 and may be collected in a method described with respect to step 150 above or may be deducted from the investment death benefit or life insurance death benefit. After the insurance premium is collected, the computer program stores the new values of the assets (if necessary) and other information necessary for implementation of this embodiment of the invention.

Next, the computer program may optionally compute the death benefit, which in this example is forty percent (40%) of the assessed investment value of $135,000 (the investment value prior to deduction of the premium) or $54,000. Thus, in this example, a beneficiary receiving payment as a lump sum would receive an annuity death benefit of $135,000—the growth of which is taxed as ordinary income at a rate of thirty-six percent (36%). As discussed above, the purchase payment of the annuity was paid with assets of which $50,000 was previously earned growth and $50,000 was purchased with after-tax assets. Consequently, the taxable portion of the annuity death benefit (i.e., the gain portion of annuity) is the value of the annuity above $50,000 or $85,000. The tax reduces the annuity death benefit by thirty-six percent (36%) of $85,000 or $30,600 resulting in an after-tax benefit of $104,400. However, in addition to the annuity death benefit, the beneficiary also receives the life insurance death benefit of $54,000 tax-free for a cumulative after-tax death benefit of $158,400. The cumulative after-tax death benefit is more than the pre-tax annuity death benefit without life insurance. In addition, the cumulative after-tax death benefit is more than the pre- tax annuity death benefit would have been, in this example scenario, even if insurance premiums had not been deducted from the annuity.

As another optional step, the computer program may credit the beneficiaries the benefits by, for example, electronically transmitting a portion, or all, of the death benefits to a financial account of the beneficiaries.

In this example embodiment of the present invention, if the beneficiary is a spouse, the spousal beneficiary may assume ownership of the annuity instead of receiving the annuity's death benefit. However, the life insurance death benefit is still paid to the spouse, who may use the life insurance death benefit ($54,000) as an additional purchase payment to the investment unless constrained by tax code limitations (e.g., contributions limits applicable to a pension plan). In addition, if the spouse meets the appropriate eligibility requirements, the spouse may elect to purchase the same kind of life insurance benefit on his or her life to increase the after- tax death benefit of the assumed annuity according to the present invention. If the spousal beneficiary elects to do so, the value of the investment is periodically assessed, insurance premium determined, and insurance premium collected as discussed above and according to the flow diagram of FIG. 2. At the death of the spouse, the new beneficiaries would then receive the annuity death benefit, the growth of which is taxed as ordinary income, and the life insurance death benefit (based on the spouse's death) tax-free.

Annuities often have two owners in which case an insurance premium according to the preferred embodiment of the present invention is determined for each and may be debited cumulatively, or separately or in an alternate embodiment may be determined and collected based on joint life expectancies. In addition, the life insurance death benefit is paid upon the death of the first of either owner.

While the example embodiment above includes step 110, which is the step of receiving the purchase information, some embodiments of the present invention may not require this step. More specifically, in some embodiments the computer program may need only to retrieve the information from a remote source (or any source) to determine the insurance premium at step 140 to practice the present invention. In addition, the steps, and order of the steps of the present invention, will vary according to the implementation of the present invention as will be understood to one skilled in the art. Likewise, some embodiments may not collect the insurance premium at step 150, but instead output information relating to the determined insurance premium (and amount of insurance), for example, to an insurance provider who collects the premium.

While the above example embodiment discloses providing a life insurance benefit that is a percentage of the entire account, variations that may (or may not) employ a flat percentage of the entire account value are also available for implementing the present invention. For example, the life insurance benefit could be calculated as a first percentage of the purchase payments and a second percentage of the gain. Such an embodiment would be most suitable for an investment product in which the gain and purchase payments are taxed at different rates thereby providing death benefits proportional to the maximum anticipated tax on the gain and purchase payments.

Furthermore, while the disclosed embodiment computes a premium for providing a death benefit that is forty (40%) of the value of the investment, any suitable proportion or percentage of the investment (which may be different for different portions of the investment) may be selected for computing the premium and providing the life insurance death benefit. For example, alternate embodiments might provide a life insurance benefit, and compute premiums based, on a higher (e.g., fifty percent (50%)) or lower (e.g., thirty percent (30%)) percentage of the investment. The life insurance benefit and its premiums may also vary based on the estimated tax rates, which may vary depending on the tax rate, tax bracket, country, state, city, and/or timing. Likewise, the proportion or percentage of the investment on which the life insurance benefit and its premiums are based may vary over time (e.g. increase or decrease each year). Also, while the preferred embodiment does not take into consideration any guaranteed minimum death benefit for the investment, alternate embodiments might do so.

In addition, the computer program may optionally transfer assets (e.g., an electronic fund transfer) sufficient to pay for the computed insurance premium (e.g., based on forty percent of the investment value) or a portion of the computed insurance premium to a third party insurance provider to provide the life insurance benefit. The value of assets transferred may be the amount collected from the investor or a portion of the amount collected. In addition to assets for paying the premium, information may also be transmitted to the insurance provider such as the investor's birth date, insurance death benefit, and other information as necessary for the particular implementation.

In the preferred embodiment, the computer program transfers assets sufficient to purchase a life insurance death benefit equal to forty percent (40%) of the purchase payment to a third party insurance provider and the institution offering the investment product according to the present invention insures the gain of the investment for forty percent (40%). Thus, the third party insurance provider thereby reinsures the portion of the life insurance death benefit attributable to purchase payments. Therefore, the present invention may, in effect, split the risk between a direct insurance provider and a reinsurer such that one insurer bears the risk relating to that portion of the death benefit based on purchase payments (or other portion thereof) and the other insurer bears the risk in relation to the other portion of the death benefit (such as the investment gain). Preferably, the third party insurance provider reinsures the contracts at a flat rate (e.g., a certain premium per one thousand dollars) so that, once the life insurance is issued, additional information (other than the amount of insurance needed) relating to particular insured lives need not be supplied to the third party insurance provider.

To further protect the insurer offering the life insurance (which may be the institution offering the investment product), the provider may design the product to permit an increase to the insurance rates (up to a predetermined maximum and subject to applicable regulatory mandates), which are then stored in memory and used to compute future premiums.

The computer implementing the present invention may impose various restrictions as are well-known in the art. For example, one restriction may be an age restriction imposing a minimum age of forty and maximum of ninety-five for the age of a person entering into the life insurance contract. Another restriction might limit payment of the life insurance death benefit if the applicable death occurs within a predetermined time period (e.g., two years) from the annuity contract date. If such a restriction is imposed and the owner dies within the predetermined time period, the life insurance premiums are preferably credited to the annuity account to be included in the annuity death benefit. Still another restriction might impose limitations on the maximum death benefit (e.g., such as being limited to one hundred percent (100%) of the purchase payments increased at five percent (5%) per year from the annuity contract date to the date of the death). The preferred embodiment does not require underwriting (includes guaranteed issue insurance) and, therefore, does not require a physical exam, medical questionnaire, medical records, or blood or urine tests required to purchase the life insurance. However, other embodiments may require underwriting, and therefore, may have fewer of the above-identified restrictions and/or be subject to different current and/or guaranteed charges.

In the preferred embodiment, if death of the investor occurs prior to the annuity's contract anniversary following the investor's ninety-fifth birthday, the sum of the following is paid to the investor's beneficiaries: forty percent (40%) of the lesser of the sum of purchase payments or $1,000,000, minus forty percent (40%) of purchase payments received within the two years preceding death, plus forty (40%) of the excess of the account value at time of the investor's death over total purchase payments (i.e., investment growth), plus fifty percent (50%) of any charge assessed with respect to purchase payments received within the two years preceding death, plus fifty percent (50%) of the sum of any charges paid with respect to purchase payments in excess of $1,000,000 (which is a refund of charges for purchase payments with respect to which no benefit will be paid), minus any pro-rata charge due for the partial year of coverage provided in the year of the death (as previously described).

Numerous events may prompt an assessment of the investment value, a determination of the insurance premium (and possibly insurance amount), and a collection of the insurance premium according to the steps of FIG. 3. For example, in the case of an annuity, if the owner surrenders a portion of the annuity the value of the investment is assessed, the prorated insurance premium is determined (based on the prorated portion of the time period prior to the surrender), and insurance premium collected as discussed above with respect FIG. 3 as described with the processes that occur at the death of the owner. After the surrender of a portion of the annuity, a new time period (i.e., the time period after which the above described steps are performed) is begun. Alternately, the original time period may remain in effect so that at the end of the time period a value of the investment is assessed, the prorated insurance premium is determined (based on the prorated portion of the time period after the surrender), and insurance premium collected as discussed above.

Similarly, if the owner terminates the life insurance benefit, the value of the investment is assessed, the prorated insurance premium is determined (based on the prorated portion of the time period prior to the termination), and the insurance premium collected or returned as discussed above with respect FIG. 3.

The present invention also allows for an accelerated death benefit for a terminally ill investor that allows a portion of the life insurance death benefit to be prepaid. If the conditions for prepayment of the life insurance benefit are satisfied (considerations which are well known in the art), a portion of what would be payable as the life insurance death benefit is payable to the owner as a prepayment. When a prepayment is to be paid, the investment is assessed, the prorated insurance premium is determined (based on the prorated portion of the time period prior to the prepayment), and the insurance premium is collected as discussed above with respect FIG. 3. In the preferred embodiment, only a portion of the death benefit (fifty percent (50%) up to $100,000) is available if the investor is certified as terminally ill. Any amount advanced is recovered from the death proceeds along with accumulated interest at six percent (6%) per annum. Terminal illness must be certified by a physician, and is defined in this example embodiment as eighty percent (80%) or higher probability of death occurring within twelve months.

In the preferred embodiment, the life insurance is fashioned through a rider that is attached to an annuity product. However, any suitable means of contracting the life insurance may be used. In addition, while the life insurance of the preferred embodiment does not accumulate a cash value, life insurance of other embodiments of the present invention might be designed such that a cash value might be provided.

In the preferred embodiment, the death benefit terminates upon annuitization. However, in other embodiments the death benefit might continue after annuitization. In the former, it is preferable to assess the value of the investment, and determine the insurance premium just prior to paying the annuity payment. This is preferable because the life insurance death benefit that would have been received (if the annuitant would have died during that time period) corresponds to the value of the investment prior to the reduction in its value by the payment of the annuity payment. Thus, the life insurance premium, when calculated in arrears, may often be more accurately calculated by using the investment value prior to deduction of the annuity payment. In addition, if possible (e.g., if the annuity payment is large enough) it may be advantageous and/or desirable to deduct the insurance premium (or a portion of it) from each annuity payment.

While the above examples compute the insurance premium in arrears, an alternate embodiment might calculate the insurance premium at the beginning of a time period based on the estimated maximum growth of the investment. Likewise, another embodiment might base the life insurance premium on the average of each periodic value (daily, monthly, quarterly), the peak value, or some other computable or estimable value.

As discussed, withdrawal of assets from a tax-deferred investment generally is a taxable distribution to the extent the gain is withdrawn and may incur a penalty if the taxpayer is under fifty-nine and a half (59½). Thus, for some investments, it may be more economically advantageous to pay the premium from other assets such as checking account, savings account, money market account or other account. It is preferable to have the payment automatically debited from the designated account by the computer program. If, however, the funds are not available or no designation has been made, the premium is automatically deducted from the investment. In the case the preferred embodiment, the premium is deducted from the variable investments (e.g., mutual funds) of the annuity first and, after depletion of the variable investments, deducted from the fixed investments of the annuity (e.g., cash).

V. System Hardware

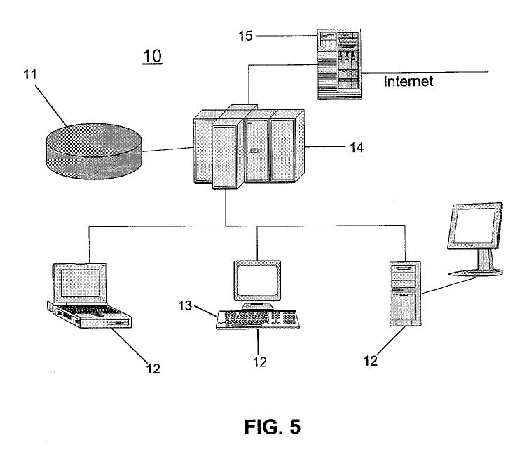

FIG. 5 is an illustration of a representative computer system for implementing the system, method, and computer program product of the present invention. Referring to FIG. 5, as described above, the process for managing the assets of the present invention may be advantageously implemented using a computer program executing on a computer system 10 having a processor or central processing unit 14, such as, for example, an IBM AS/400, having a memory 11, such as, for example, a hard drive, RAM, ROM, a compact disc, magneto-optical storage device, and/or fixed or removable media, having a one or more user interface devices 12, such as, for example, computer terminals, personal computers, laptop computers, and/or handheld devices, with an input means, such as, for example, a keyboard 13, mouse, pointing device, and/or microphone. The computer program is stored in memory 11 along with various other data including investor information, investment data, account information, asset information, allocation of investor assets, transaction cost data, fee data, mortality tables, insurance premium rates, communication information, and other parameters and data necessary to implement the method of the present invention.

In addition, the computer system 10 is coupled to a computer network, which may also be communicatively coupled to the Internet and/or other computer network to facilitate the buying and selling of investments electronically through an electronic communications network (ECN) such as, for example, Island (ISLD); Instinet (INCA); Terranova (TNTO); Attain (ATTN); Bloomberg Tradebook (BTRD); Spear, Leads, & Kellogg (REDI); and NASDAQ.

Optionally, information and other data including investor information, investment data, account information, asset information, allocation of investor assets, transaction cost data, fee data, mortality tables, insurance premium rates, communication information, and other parameters and data necessary to implement the method of the present invention could be stored externally of the system 10 and received through the Internet or other communication network in a manner well-known in the art for processing by the system 10. Also, the system software for implementing the method of the present invention could be implemented, wholly or partly, on a personal computer, laptop computer, handheld device, or like communication device or appliance for performing the processing steps of the present invention. The computer system 10 of the present invention may also include a web server 15.

The foregoing merely illustrates the principles of the invention. It will thus be appreciated that those skilled in the art will be able to devise various arrangements which, although not explicitly described or shown herein, embody the principles of the invention and are thus within its spirit and scope.

The computer program and software modules of the system, method, and computer program product of the present invention can be implemented using any operating system, and associated hardware including, but not limited to, Unix, Linux, VMS, IBM, Microsoft Windows NT, 95, 98, 2000, ME, and XP, Palm OS, Microsoft Windows CE and the like.

The systems, processes, and components set forth in the present description may be implemented using one or more general purpose computers, microprocessors, or the like programmed according to the teachings of the present specification, as will be appreciated by those skilled in the relevant art(s). Appropriate software coding can readily be prepared by skilled programmers based on the teachings of the present disclosure, as will be apparent to those skilled in the relevant art(s). The present invention thus also includes a computer-based product which may be hosted on a storage medium and include instructions that can be used to program a computer to perform a process in accordance with the present invention. The storage medium can include, but is not limited to, any type of disk including a floppy disk, optical disk, CDROM, magneto-optical disk, ROMs, RAMs, EPROMs, EEPROMs, flash memory, magnetic or optical cards, or any type of media suitable for storing electronic instructions, either locally or remotely.

The foregoing has described the principles, embodiments, and modes of operation of the present invention. However, the invention should not be construed as being limited to the particular embodiments described above, as they should be regarded as being illustrative and not as restrictive. It should be appreciated that variations may be made in those embodiments by those skilled in the art without departing from the scope of the present invention.

While a preferred embodiment of the present invention has been described above, it should be understood that it has been presented by way of example only, and not limitation. Thus, the breadth and scope of the present invention should not be limited by the above described exemplary embodiment.

Obviously, numerous modifications and variations of the present invention are possible in light of the above teachings. It is therefore to be understood that within the scope of the appended claims, the invention may be practiced otherwise than as specifically described herein.

What is claimed is:

1. A method for managing an investment for an investor to increase the after-tax death benefit of the investment, comprising the steps of:
assessing a first value of the investment;
determining a first life insurance death benefit based on said first value;
determining a first premium of said first life insurance death benefit;
receiving said first premium; and
providing life insurance for said first life insurance death benefit.

2. The method of claim 1, further comprising the steps of:
receiving information of the death of the insured;
assessing a second value of the investment in response to receiving said information;
determining a second life insurance death benefit based on said second value; and
determining a prorated premium of said second life insurance death benefit.

3. The method of claim 1, further comprising the steps of:
receiving information of an anticipated withdrawal of a portion of the investment;
assessing a second value of the investment in response to receiving said information;
determining a second life insurance death benefit based on said second value; and
determining a prorated premium of said second life insurance death benefit based.

4. The method of claim 1, wherein said step of receiving said first premium includes debiting funds from assets not in the investment.

5. The method of claim 1, wherein said step of receiving said first premium includes debiting assets in the investment.

6. The method of claim 1, wherein said steps of assessing, determining and receiving are performed periodically.

7. The method of claim 1, further comprising the step of comparing said first premium with a maximum charge.

8. The method of claim 1, further comprising the steps of:
storing a date of birth of the insured in a memory; and
wherein said first premium is based, at least in part, on said date of birth of the insured.

9. The method of claim 1, wherein said first life insurance death benefit is a percentage of said first value.

10. The method of claim 9, wherein said percentage of said first value is greater than the maximum tax rate.

11. The method of claim 9, wherein said percentage of said first value is forty percent.

12. The method of claim 1, wherein the investment is an annuity.

13. The method of claim 2, further comprising the step of providing said life insurance death benefit.

14. The method of claim 1, further comprising the steps of:
assessing a second value of the investment;
determining a second life insurance death benefit based on said second value;
determining a second premium of said second life insurance death benefit;
receiving said second premium;
providing life insurance for said second life insurance death benefit; and
wherein said first life insurance death benefit is different from said second life insurance death benefit.

15. A computer system for managing an investment for an investor to increase the after-tax death benefit of the investment, comprising:
means for assessing a first value of the investment;
means for determining a life insurance death benefit based on said first value;
means for determining a first premium of said first life insurance death benefit;
means for receiving said first premium; and
means for providing life insurance for said first life insurance death benefit.

16. The computer system of claim 15, further comprising the steps of:
means for receiving information of the death of the insured;
means for assessing a second value of the investment in response to receiving said information;
means for determining a second life insurance death benefit based on said second value; and
means for determining a prorated premium of said second life insurance death benefit.

17. The computer system of claim 15, further comprising the steps of:
means for receiving information of an anticipated withdrawal of a portion of the investment;
means for assessing a second value of the investment in response to receiving said information;
means for determining a second life insurance death benefit based on said second value; and
means for determining a prorated premium of said second life insurance death benefit.

18. The computer system of claim 15, wherein said means for receiving said first premium includes debiting funds from assets not in the investment.

19. The computer system of claim 15, wherein said means for receiving said first premium includes debiting assets in the investment.

20. The computer system of claim 15, wherein said means for assessing, said means for determining, and said means for receiving are implemented periodically.

21. The computer system of claim 15 further comprising means for comparing said first premium with a maximum charge.

22. The computer system of claim 15, further comprising:
means for storing a date of birth of the insured in a memory; and
wherein said first premium is based, at least in part, on said date of birth of the insured.

23. The computer system of claim 15, wherein said first life insurance death benefit is a percentage of said first value.

24. The computer system of claim 23, wherein said percentage of said first value is greater than a maximum tax rate.

25. The computer system of claim 23, wherein said percentage of said first value is forty percent.

26. The computer system of claim 15, wherein the investment is an annuity.

27. The computer system of claim 16, further comprising means for providing said life insurance death benefit.

28. The computer system of claim 15, further comprising:
means for assessing a second value of the investment;
means for determining a second life insurance death benefit based on said second value;
means for determining a second premium of said second life insurance death benefit;
means for receiving said second premium;
means for providing life insurance for said second life insurance death benefit; and
wherein said first life insurance death benefit is different from said second life insurance death benefit.

29. A computer program embodied on a computer readable medium for managing an investment for an investor to increase the after-tax death benefit of the investment, comprising:
a code segment which assesses a first value of the investment;
a code segment which determines a first life insurance death benefit based on said first value;
a code segment which determines a first premium of said first life insurance death;
a code segment which receives said first premium; and
a code segment which provides life insurance contract for said first life insurance death benefit.

30. The computer program of claim 29, further comprising:
a code segment which receives information of the death of the insured;
a code segment which assesses a second value of the investment in response to receiving said information;
a code segment which determines a second life insurance death benefit based on said second value; and
a code segment which determines a prorated premium of said second life insurance death benefit.

31. The computer program of claim 29, further comprising:
a code segment which receives information of an anticipated withdrawal of a portion of the investment;
a code segment which assesses a second value of the investment in response to receiving said information;
a code segment which determines a second life insurance death benefit based on said second value; and
a code segment which determines a prorated premium of said second life insurance death benefit.

32. The computer program of claim 29, wherein said a code segment which receives said first premium debits funds from assets not in the investment.

33. The computer program of claim 29, wherein said a code segment which receives said first premium debits assets in the investment.

34. The computer program of claim 29, wherein said a code segments which assess, determine and receive perform said respective tasks periodically.

35. The computer program of claim 29, further comprising a code segment which compares said first premium with a maximum charge.

36. The computer program of claim 29, further comprising:
a code segment which stores a date of birth of the insured in a memory; and
wherein first premium is based, at least in part, on said date of birth of the insured.

37. The computer program of claim 29, wherein said first life insurance death benefit is a percentage of said first value.

38. The computer program of claim 37, wherein said percentage of said first value is greater than the maximum tax rate.

39. The computer program of claim 37, wherein said percentage of said first value is forty percent.

40. The computer program of claim 29, wherein the investment is an annuity.

41. The computer program of claim 30, further comprising a code segment which provides said life insurance death benefit.

42. The computer program of claim 29, further comprising:
a code segment which assesses a second value of the investment;
a code segment which determines a second life insurance death benefit based on said second value;
a code segment which determines a second premium of said second life insurance death benefit;
a code segment which receives said second premium;
a code segment which provides a life insurance contract for providing said second life insurance death benefit; and
wherein said first life insurance death benefit is different from said second life insurance death benefit.
